(19) United States
(12) Patent Application Publication
(10) Pub. No.: US 2026/0339810 A1
(43) Pub. Date: Oct. 29, 2026

(54) EVENT PERFORMANCE METHOD AND APPARATUS BASED ON USER BEHAVIOR PREDICTION, MEDIUM, AND DEVICE

(71) Applicant: Alipay (Hangzhou) Digital Service Technology Co., Ltd., Hangzhou (CN)

(72) Inventors: Yu CHENG, Hangzhou (CN); Baokun WANG, Hangzhou (CN); Xing FU, Hangzhou (CN); Weiqiang WANG, Hangzhou (CN)

(21) Appl. No.: 19/663,074

(22) Filed: Apr. 29, 2026

(30) Foreign Application Priority Data
Apr. 29, 2025 (CN) 202510561007.9

(51) Int. Cl. G06F 11/34; G06F 11/30

(52) U.S. Cl. CPC G06F 11/3438; G06F 11/3072

(57) ABSTRACT

Implementations of the present specification disclose an event performance method and apparatus based on user behavior prediction, a storage medium, and a device. Multimodal user data including at least behavior data is obtained, data of each modality is tokenized by using a sub-encoder of each modality branch in a prediction model to obtain a sub-feature of each modality through encoding, each sub-feature is further encoded to obtain a comprehensive feature, then a prediction advantage of a large language model is used to obtain a prediction result of a user behavior by using the comprehensive feature as an input, and finally an event policy of a target event is determined and performed based on the prediction result and the target event. The obtained multimodal user data is not limited to a certain event, a user behavior can be more accurately predicted by integrating behavior data with data of another modality, and an underlying cause can be better analyzed by using a reasoning capability of the large language model, making a prediction result more logical.

### CROSS-REFERENCE TO RELATED APPLICATION

The present application claims priority to Chinese Patent Application No. 202510561007.9, filed on Apr. 29, 2025, the contents of which are incorporated herein by reference, in their entirety.

### TECHNICAL FIELD

The present specification relates to computer technologies, and in particular, to an event performance method and apparatus based on user behavior prediction, a medium, and a device.

### BACKGROUND

Currently, with development of information technologies, personalized businesses for users have become core competency of events. Deeply analyzing historical behaviors of users to predict interests and preferences of the users and executing events based on prediction results have become important means to attract and retain the users. Therefore, user behavior mode understanding and user behavior prediction have become important foundational tasks for event development.

In the related technologies, when user behavior prediction is performed, user data related to an event is first obtained based on expert experience, and then user behavior prediction is performed by using a pre-trained prediction model. Therefore, the prediction model can only be applied to the vertical field corresponding to the event. For example, travel-related events predict users' demand for tickets, hotels, and the like based on users' ride-hailing and travel records. However, in this way, an application scenario of the prediction model is limited, and different event scenarios require targeted training models, increasing operation and maintenance costs. In addition, obtaining some data based on expert experience for prediction also makes data used in prediction incomplete, making it difficult to improve accuracy.

### SUMMARY

Inventors observed that both data required for behavior prediction and feature engineering during construction of the prediction model mainly rely on expert experience, resulting in insufficient accuracy and flexibility of the prediction model, making it difficult to continuously improve event application effect, and especially causing huge challenges in deeply exploring users' underlying true preferences and understanding underlying motives of data.

The present specification provides an event performance method based on user behavior prediction, which, among others, resolve technical problems in the related technologies.

An implementation of the present specification provides an event performance method based on user behavior prediction. Multimodal user data including at least behavior data is obtained, data of each modality is tokenized by using a sub-encoder of each modality branch in a prediction model to obtain a sub-feature of each modality through encoding, each sub-feature is further encoded to obtain a comprehensive feature, then a prediction advantage of a large language model is used to obtain a prediction result of a user behavior by using the comprehensive feature as an input, and finally an event policy of a target event is determined and performed based on the prediction result and the target event. The obtained multimodal user data is not limited to a certain event, a user behavior can be more accurately predicted by integrating behavior data with data of another modality, and an underlying cause can be better analyzed by using a reasoning capability of the large language model, making a prediction result more logical. The method includes: obtaining multimodal user data, where the user data includes at least behavior data of a user; for user data of each modality, tokenizing and encoding the user data of the modality by using a sub-encoder corresponding to the modality in a trained prediction model to obtain a sub-feature of the modality; inputting the sub-feature of each modality into an overall encoder of the prediction model to obtain a comprehensive feature; inputting the comprehensive feature into a large language prediction layer of the prediction model as descriptive information of a historical user behavior to obtain a prediction result of a user behavior output by the prediction model; and determining an event policy based on the prediction result and a target event to perform the event for the user based on the event policy.

In some implementations, the obtaining the multimodal user data including at least the behavior data of the user includes: obtaining, based on predetermined duration, operation data of the user in different event scenarios in the duration as behavior data of the user, and obtaining data of another modality of the user; and determining user data based on the behavior data and the data of the another modality, where the data of the another modality includes at least one of static data, text data, or graph data.

In some implementations, the obtaining the data of the another modality of the user includes: obtaining basic data of the user as static data of the user.

In some implementations, the obtaining the data of the another modality of the user includes: obtaining, based on a historical event performed by the user, text information in the historical event as text data of the user.

In some implementations, the obtaining the data of the another modality of the user includes: determining a relationship between the user and another object based on event information, where the another object includes at least one of another user, a device, or an environment; and constructing graph data of the user based on the relationship.

In some implementations, the method further includes: before the tokenizing the user data of the modality by using the sub-encoder corresponding to the modality in the trained prediction model to obtain the sub-feature of the modality, standardizing the user data of the modality based on a predetermined data style of the modality to obtain standardized user data of the modality.

In some implementations, the tokenizing the user data of the modality by using the sub-encoder corresponding to the modality in the trained prediction model to obtain the sub-feature of the modality includes: inputting the user data of the modality into the sub-encoder corresponding to the modality in the prediction model, and tokenizing the user data of the modality to obtain each piece of token data of the modality; and continuing to perform self-attention weighting on each piece of token data of the modality by using the sub-encoder of the modality, and then outputting the sub-feature of the modality through a feed-forward neural network of the sub-encoder of the modality.

In some implementations, dimensions of the sub-features output by the sub-encoders of the modalities are consistent.

In some implementations, the inputting the user data of the modality into the sub-encoder corresponding to the modality in the prediction model, and tokenizing the user data of the modality to obtain the token data of the modality includes: for a sub-encoder of behavior data, inputting the behavior data into the sub-encoder of the behavior data, tokenizing the behavior data, and determining, based on a sequence of user behaviors in the behavior data, positional encoding corresponding to each piece of token data obtained through tokenization, where each piece of token data corresponds to one user behavior.

In some implementations, the inputting the user data of the modality into the sub-encoder corresponding to the modality in the prediction model, and tokenizing the user data of the modality to obtain the token data of the modality includes: for a sub-encoder of behavior data, inputting the behavior data into the sub-encoder of the behavior data, tokenizing the behavior data, and determining, based on an event performance procedure corresponding to the behavior data, positional encoding corresponding to each piece of token data obtained through tokenization, where each piece of token data corresponds to one user behavior.

In some implementations, the determining, based on the event performance procedure corresponding to the behavior data, the positional encoding corresponding to the token data obtained through tokenization includes: determining, based on the behavior data, different events that the behavior data is used to perform; determining, for each different event, token data obtained by tokenizing user behaviors corresponding to the event; determining, based on an event performance procedure of the event, a sequence of the user behaviors corresponding to the event; and determining positional encoding of each piece of token data of the event based on the sequence.

In some implementations, the continuing to perform self-attention weighting on each piece of token data of the modality by using the sub-encoder, and then outputting the sub-feature of the modality through the feed-forward neural network of the sub-encoder includes: for behavior data, performing unified encoding on obtained token data and positional encoding of different events by using a sub-encoder of a corresponding modality, to obtain a set of token data; and inputting the set of token data into a self-attention weighting network of the sub-encoder of the modality for weighting, and then inputting a weighting result into a feed-forward neural network of the sub-encoder of the modality to obtain a sub-feature of the modality.

In some implementations, the inputting the comprehensive feature into the large language prediction layer of the prediction model as the descriptive information of the historical user behavior to obtain the prediction result of the user behavior output by the prediction model includes: obtaining a prompt text of a predetermined large language model; using the comprehensive feature as the descriptive information of the historical user behavior; combining the prompt text and the descriptive information to obtain an input text; and inputting the input text into the large language prediction layer of the prediction model to obtain, as a prediction result, a user behavior sequence predicted by the prediction model.

In some implementations, the determining the event policy based on the prediction result and the target event to perform the event for the user based on the event policy includes: in response to the target event being a risk control event, matching the behavior data with the prediction result based on an event requirement of the risk control event; and in response to determining that the behavior data does not match the prediction result, performing risk control for the user; or in response to determining that the behavior data matches the prediction result, skipping performing risk control.

In some implementations, the determining the event policy based on the prediction result and the target event to perform the event for the user based on the event policy includes: in response to the target event being a recommendation event, matching the prediction result with a recommendation range of the recommendation event based on the recommendation range; and sending matched content in the recommendation range to the user.

In some implementations, an encoder of the prediction model is trained in the following manner: obtaining behavior data of several users; for behavior data of a same user, splitting the behavior data into multiple segments; constructing multiple pieces of multimodal user data of the user based on each segment of behavior data and data of another modality of the user as multiple training samples; for each training sample of each user, inputting the training sample into the encoder of the prediction model to obtain, by using a sub-encoder of each modality in the encoder and the overall encoder, a comprehensive feature corresponding to the training sample; and determining a function value of a loss function based on the comprehensive feature of each training sample, and adjusting a model parameter of the encoder based on the function value.

In some implementations, the determining the function value of the loss function based on the comprehensive feature of each training sample includes: determining the function value of the loss function based on a first difference of comprehensive features of training samples of a same user, where the first difference is negatively correlated with the function value; and/or determining the function value of the loss function based on a second difference of comprehensive features of training samples of different users, where the second difference is positively correlated with the function value.

An implementation of the present specification further provides an event performance apparatus based on user behavior prediction, including: an acquisition module, configured to obtain multimodal user data including at least behavior data of a user; a first encoding module, configured to: for user data of each modality, tokenize and encode the user data of the modality by using a sub-encoder corresponding to the modality in a trained prediction model to obtain a sub-feature of the modality; a second encoding module, configured to input the sub-feature of each modality into an overall encoder of the prediction model to obtain a comprehensive feature; a prediction module, configured to input the comprehensive feature into a large language prediction layer of the prediction model as descriptive information of a historical user behavior to obtain a prediction result of a user behavior output by the prediction model; and an event performance module, configured to determine an event policy based on the prediction result and a target event to perform the event for the user based on the event policy.

An implementation of the present specification further provides a computer program product. The computer program product stores at least one instruction, and the at least one instruction is adapted to be loaded by a processor and to perform the steps of the above method.

An implementation of the present specification further provides a storage medium. The storage medium stores a computer program, and the computer program is adapted to be loaded by a processor and to perform the steps of the above method.

An implementation of the present specification further provides an electronic device, including a processor and a memory. The memory stores a computer program, and the computer program is adapted to be loaded by the processor and to perform the steps of the above methods.

In implementations of the present specification, multimodal user data including at least behavior data is obtained, data of each modality is tokenized by using a sub-encoder of each modality branch in a prediction model to obtain a sub-feature of each modality through encoding, each sub-feature is further encoded to obtain a comprehensive feature, then a prediction advantage of a large language model is used to obtain a prediction result of a user behavior by using the comprehensive feature as an input, and finally an event policy of a target event is determined and performed based on the prediction result and the target event. The obtained multimodal user data is not limited to a certain event, a user behavior can be more accurately predicted by integrating behavior data with data of another modality, and an underlying cause can be better analyzed by using a reasoning capability of the large language model, making a prediction result more logical.

### BRIEF DESCRIPTION OF DRAWINGS

FIG. 1 is a schematic flowchart illustrating an event performance method based on user behavior prediction according to an implementation of the present specification;

FIG. 2 is a schematic diagram illustrating a prediction model encoder according to an implementation of the present specification;

FIG. 3 is a schematic diagram illustrating a large language prediction layer according to an implementation of the present specification;

FIG. 4 is a schematic structural diagram illustrating an event performance apparatus based on user behavior prediction according to an implementation of the present specification; and

FIG. 5 is a schematic structural diagram illustrating an electronic device according to an implementation of the present specification.

### DETAILED DESCRIPTION

To make the objectives, technical solutions, and advantages of the present specification clearer, the following clearly and comprehensively describes the technical solutions in the present specification with reference to specific implementations of the present specification and corresponding accompanying drawings. Clearly, the described implementations are merely some rather than all of the implementations of the present specification. All other implementations obtained by those of ordinary skill in the art based on the implementations of the present specification without innovative efforts all fall within the protection scope of the present specification.

Currently, in a common user behavior prediction solution, a usage minimization principle is followed from a data perspective. Each type of event uses only related data of a user in this type of event for user behavior prediction, making it difficult to improve prediction accuracy. Because actual underlying logic of a user behavior is not affected only by a single scenario, but also by a more complex problem, e.g., a reason for driving a user to implement some behaviors is generally not just related to data in a certain event scenario, but needs to be considered from the user as a whole. For example, a user purchases milk every weekend, but the user has gastroenteropathy this week and has made an appointment for a related clinic, and may suspend the purchase of milk at the weekend. If only related data of a user consumption event is used, it is difficult to predict a decrease in a probability of the user purchasing milk.

However, a prediction model obtained through related end-to-end supervised machine learning training has certain limitations on requirements for input data. Too much input data inevitably expands a model size, making parameter adjustment more difficult. Even if training can be completed, model deployment costs and operation and maintenance costs are high, and even model update costs are high. Therefore, in a related machine learning method, it is difficult to apply comprehensive user data to perform user behavior prediction to provide better support for event performance.

In addition, more complex model building more relies on expert experience for feature engineering. For example, a user behavior sequence is converted into calculation of statistical features such as a number of user payments and a payment amount. However, this approach often sacrifices data details, such as timestamps and device identifiers, and the lack of these details can also lead to model performance bottlenecks, e.g., make it difficult to improve prediction accuracy.

Therefore, related user behavior prediction solutions are all designed for a single scenario and cannot achieve universal user feature extraction for varied event scenarios, and data range limitations also lead to inherent bottlenecks in prediction accuracy.

The present specification illustrates an event performance method based on user behavior prediction, which, among others, resolves the above technical problems.

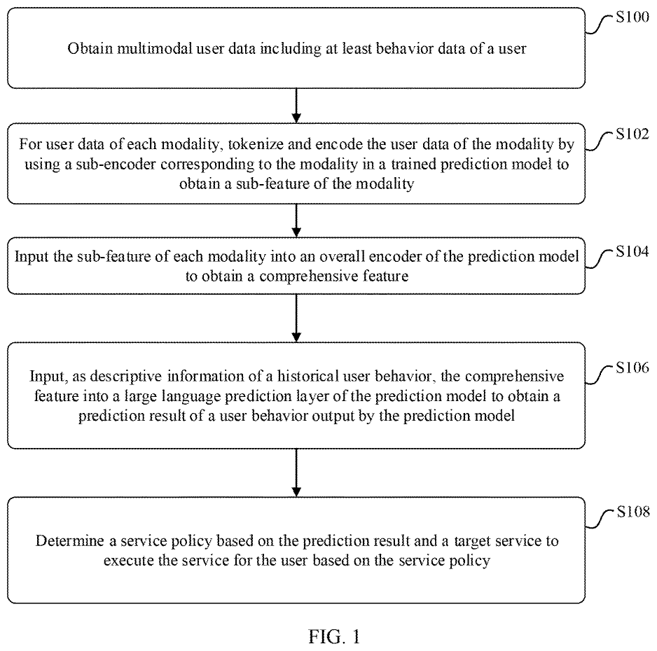

Referring to FIG. 1, a procedure is shown in detail. The procedure can include the following operations.

S100: Obtain multimodal user data including at least behavior data of a user.

Based on data generated during historical event performance by the user, event performance is currently supported for the user, to provide a personalized business for the user. For example, a current required product is recommended to the user, to reduce time for searching and browsing by the user and improve event performance efficiency. Generally, when the user initiates an event, a user behavior can be predicted, and the event can be performed based on a prediction result. In other scenarios, when the user does not initiate an event, a user behavior can also be predicted. For example, in a security risk control event, user behavior prediction can be periodically performed, to identify an underlying security risk in advance. Certainly, regardless of event logic, user data needs to be first obtained, then prediction is performed, and finally an event is performed based on a prediction result. Therefore, in one or more implementations of the present specification, the user data can be first obtained. For example, this can be performed by a server of an event provider. The server can be a single device or a distributed server including multiple devices, which is not limited in the present specification.

It should be noted that, in an implementation of the present specification, for a user who performs an event, multimodal user data of the user is obtained. In addition, user data of each modality is not limited to a certain event scenario to be performed, but user data of multiple modalities of the user in multiple event scenarios is obtained.

For example, the server can obtain user data of the user in each event scenario based on a user identifier of the user. The user data includes at least behavior data of the user in each event scenario, e.g., a sequence of a series of user behaviors indicating what operations the user performed on what device at what time. For example, on Jan. 1, 2025, the user clicked on a “My Wallet” page to claim a red envelope at 12:31, and then purchased a 1 L carton of milk at a FamilyMart convenience store and paid 20.8 yuan at 15:31.

In addition, in the present specification, the behavior data is not subjected to conventional feature engineering, but is used for subsequent tokenization (tokenization), to reduce loss of detail information caused by statistical processing on the behavior data.

In addition, the user data further includes data of another modality, and includes at least one of static data, text data, or graph data.

The server can obtain basic data of the user based on the user identifier of the user as static data of the user. The basic data is generally data that does not change for the user over a certain period of time, for example, age, gender, and various statistical information. The statistical information is generally information obtained by collecting statistics on an event that has been performed in the past, for example, expenditure of the previous year or a number of each type of event performed in the previous year. This type of statistical data will no longer change, and therefore can be used as basic data of the user, e.g., can be used as static data in the present specification and obtained by the server.

The server can further obtain, based on a historical event performed by the user, text information in the historical event as text data of the user. The text information in the historical event includes text information browsed by the user, introduction information about a business used by the user, product information of a product purchased by the user, and the like. In an implementation of the present specification, a context relationship between text information is not required, but only text information that may be associated with the user when the user performs the historical event needs to be first obtained. Since information actually obtained by the user from a text cannot be determined in a data preparation phase, and text information processing is relatively faster and less costly, a large amount of text data can be obtained, and then filtered by a model in a subsequent phase.

The server can further determine a relationship between the user and another object based on event information, and construct graph data of the user based on the relationship. The another object includes at least one of another user, a device, or an environment. For example, the server can further determine graph data between the user and the another user, graph data between the user and the device, and graph data between the user and the environment (for example, a geographical position). The above several types of graph data can be independent graph data or one piece of graph data, which can be obtained in a form in which the server pre-generates graph data. Certainly, an object type in the above several types of graph data is only an example. An implementation of the present specification does not limit the graph data to another type of object, for example, graph data between the user and an event scenario, which can be set as required.

Finally, the above multimodal data can be used by the server as user data by using several combinations, and a specific combination to be selected is not limited in the present specification and can be set as required.

In addition, when obtaining the behavior data of the user, the server can use, based on predetermined duration, operation data of the user in different event scenarios in the duration starting from a current moment as the behavior data of the user. An existing user has a lot of operation data, and a behavior habit of the user may change over time. Therefore, obtaining behavior data in a recent period of time better satisfies a user behavior prediction requirement, and yields a more accurate prediction result.

Certainly, in one or more implementations of the present specification, the server can alternatively or additionally obtain user data in some event scenarios. For example, an amount of data to be obtained can be set as required, and more comprehensive data obtained indicates a more accurate prediction result and better event performance effect. For example, a more accurate recommended product indicates that an event provided better satisfies a user requirement. However, it is not limited in the present specification that user data in all possible event scenarios needs to be obtained. For example, if the event provider provides ten types of events, the server can obtain user data of seven types of events, or can obtain user data of the ten types of events, or can obtain user data of one type of event. Wider event scenarios corresponding to obtained user data indicate more accurate prediction, and an appropriate event scenario reduction can also increase a prediction speed. When a timeliness requirement is high, event scenarios corresponding to user data can be reduced as required. For example, this can be set as required, and is not limited in the present specification. For example, the event provider independently performs setting based on expert experience.

It should be noted that differences in user data in different event scenarios may lie in behavior data. Similar to static data and graph data, this is generally less related to an event scenario. Therefore, such data in different event scenarios may be completely consistent, and the server can obtain only uniform of such data.

S102: For user data of each modality, tokenize and encode the user data of the modality by using a sub-encoder corresponding to the modality in a trained prediction model to obtain a sub-feature of the modality.

S104: Input the sub-feature of each modality into an overall encoder of the prediction model to obtain a comprehensive feature.

In one or more implementations of the present specification, after obtaining the user data, the server can encode the user data of each modality by using the sub-encoder of the modality in the trained prediction model to obtain the sub-feature representing the user data of the modality, and then obtain, through integration based on the sub-feature of each modality, the comprehensive feature representing a user behavior feature.

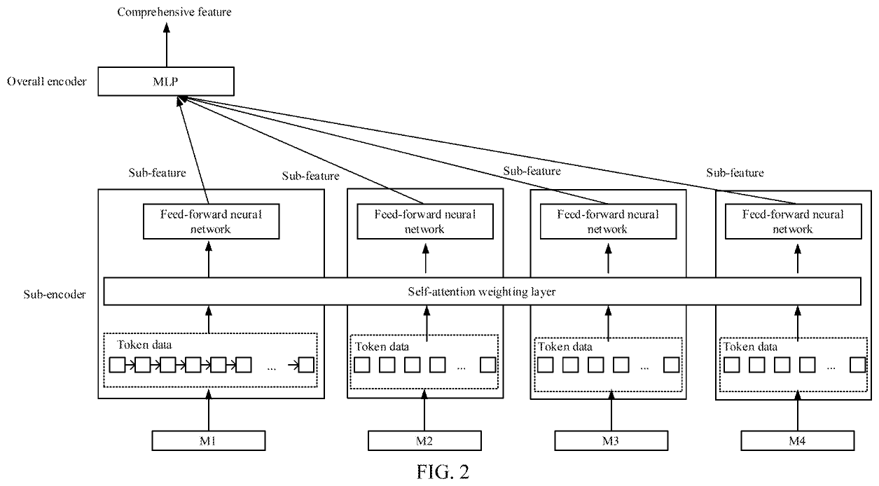

FIG. 2 is a schematic diagram illustrating a prediction model encoder according to an implementation of the present specification. For example, the encoder uses four modalities denoted by M1 to M4, which are respectively behavior data, static data, text data, and graph data. It can be learned that data of each modality has a dedicated sub-encoder for outputting a sub-feature, and subsequently an overall encoder is used to obtain a comprehensive feature of a user.

For example, first, for user data of each modality, the server can input the user data of the modality into the sub-encoder corresponding to the modality in the prediction model, and tokenize (tokenize) the user data of the modality to obtain each piece of token data, e.g., token, of the modality.

Then, self-attention weighting continues to be performed on each piece of token data of the modality by using the sub-encoder of the modality, and then a sub-feature of the modality is output through a feed-forward neural network of the sub-encoder of the modality. A model structure for performing tokenization and obtaining a sub-feature can adopt an encoder structure of a Transformer model. As shown in FIG. 2, a token sequence of each modality is obtained through encoding first, then weighted by using a self-attention layer of each modality, and finally applied to each position of a weighted token sequence through the feed-forward neural network (Feed-Forward Neural Network, FFN). The half is two-layer linear transformation from low dimension to high dimension and back to low dimension, with an activation function in high dimension for activation.

Certainly, the present specification does not limit the model structure for tokenization in this sub-encoder. Model structures like a recurrent neural network (Recurrent Neural Network, RNN), a long short-term memory (Long Short-Term Memory, LSTM), and a gated recurrent unit (Gated Recurrent Unit, GRU) can encode information in a sequence by using their internal states, and are applicable to processing ordered data such as a sentence. Alternatively or additionally, a local feature is captured through a convolutional neural network (Convolutional Neural Networks, CNN) by using a sliding window.

In addition, for behavior data, a sequence feature of the token sequence can also be added through positional encoding (Positional Encoding). Since a self-attention mechanism itself does not consider position information of an input token, positional encoding is added to input embedding to inject information about the token sequence. For data of other modalities, since there is generally no clear sequence relationship, positional encoding can be set to a consistent value, for example, all set to 0 or all set to 1.

It should be noted that, to facilitate subsequent steps to integrate the sub-features of the modalities, the sub-encoders of the modalities are set to output sub-features of a same dimension, for example, all output a 512-bit vector, e.g., dimensions of the sub-features output by the sub-encoders of the modalities are consistent.

Finally, the comprehensive feature output by the overall encoder is obtained by inputting the sub-features of the modalities into the overall encoder. A dimension of the comprehensive feature can be consistent with the dimension of the sub-feature, and the overall encoder can use an MLP structure. The sub-features of the modalities are spliced in a predetermined sequence to obtain input data. The comprehensive feature includes a comprehensive feature of behavior habits, various relationships, and basic information of the user in different event scenarios, and can better include feature information of underlying behavior logic of the user. The comprehensive feature is not limited to a certain event scenario, but represents the user as a whole, and therefore can be applied to different event scenarios. Therefore, the above steps S100 to S104 can also be periodically performed, to obtain the latest representation of the user, reduce time consumed in calculating a feature when event performance is supported, and improve event performance timeliness. For example, a comprehensive feature of the user is calculated at the end of each day to support event performance of the next day.

S106: Input the comprehensive feature into a large language prediction layer of the prediction model as descriptive information of a historical user behavior to obtain a prediction result of a user behavior output by the prediction model.

After the comprehensive feature is obtained, the user behavior can be predicted. In one or more implementations of the present specification, because a user behavior sequence is predicted, the server can derive future user behaviors one by one by using a sequential reasoning capability of a large language model (Large Language Model, LLM). In addition, based on a reasoning process, a reason for a predicted user behavior and an underlying cause can be further obtained, and can also be used for event performance.

For example, the server first obtains a prompt text of a predetermined large language model, for example, and predicts a future user behavior based on a subsequent description feature of the historical user behavior.

Then, the comprehensive feature is used as the descriptive information of the historical user behavior, and the prompt text and the descriptive information are combined to obtain an input text.

Finally, the input text is input into the large language prediction layer of the prediction model to obtain, as a prediction result, a user behavior sequence predicted by the prediction model.

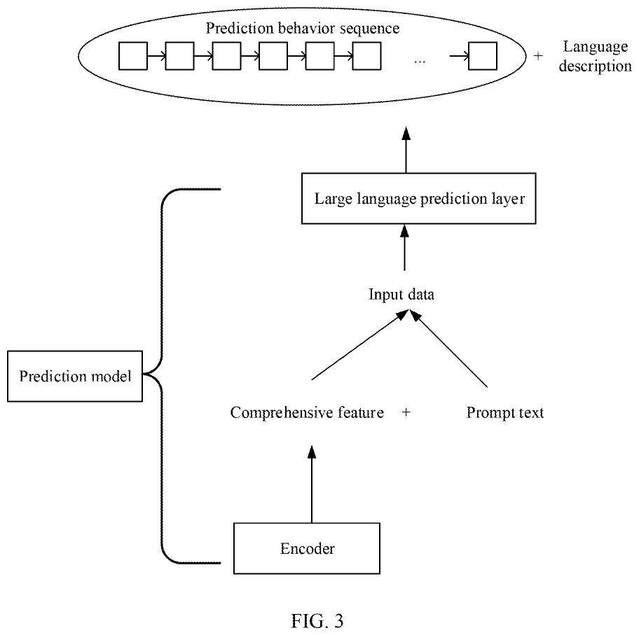

FIG. 3 is a schematic diagram illustrating a large language prediction layer according to the present specification. It can be learned that a comprehensive feature and a prompt text are combined and input into the large language prediction layer, and the large language prediction layer outputs a predicted behavior sequence and a text description.

Because the encoder outputs a feature vector rather than text information, the server can consider the feature vector as a text representation, e.g., descriptive information of a historical user behavior, and assist in obtaining input data by using a predetermined prompt text. Then, the input data is input into the large language prediction layer of the prediction model, to obtain a prediction result output by the large language prediction layer.

The prediction result output by the large language prediction layer is a user behavior sequence, and a number of user behaviors included in the sequence is not limited. This is one of LLM features. An amount of output data given varies with input data.

In some implementations, the LLM outputs not only a predicted behavior sequence, but also a text description corresponding to each user behavior in the behavior sequence. Content included in a text description can be implemented based on fine tuning of the large language prediction layer. For example, the text description can include a specific description of a user behavior, and a description of a reason for predicting a user behavior.

S108: Determine an event policy based on the prediction result and a target event to perform the event for the user based on the event policy.

In one or more implementations of the present specification, after obtaining the predicted user behavior, the server can determine, based on the event policy of the target event that needs to be performed and the prediction result, how to perform the event.

For example, when the target event is a risk control event, the server can match, based on an event requirement of the risk control event, behavior data used for prediction with the prediction result obtained through prediction.

If it is determined that the behavior data does not match the prediction result, it indicates that the predicted user behavior is quite different from the historical user behavior, e.g., the user may have acted abnormally. In this case, risk control needs to be performed for the user.

If it is determined that the behavior data matches the prediction result, it indicates that the user behaviors are consistent throughout, and the user has acted normally. In this case, risk control is not required.

In addition, the above implementation is only an example case. The server can also obtain multiple abnormal user behavior templates in the risk control event, and match an abnormal behavior template with the prediction result. If the abnormal behavior template matches the prediction result, it indicates that there is an abnormal user behavior, and risk control is performed for the user. If the abnormal behavior template does not match the prediction result, risk control is not performed.

Alternatively or additionally, the prediction result is directly input into a risk control model to determine whether an anomaly exists.

In one or more implementations of the present specification, the above implementation is merely described by using the risk control event as an example. However, actually, the target event can alternatively or additionally be another type of event, for example, an information recommendation event or a business recommendation event. When the target event is a recommendation event, the prediction result is matched with a recommendation range of the recommendation event based on the recommendation range. Matched content in the recommendation range is sent to the user.

In this case, the operation policy is to recommend, based on a user behavior, information or a server that matches a user behavior. Similarly, a mature user behavior-based recommendation solution can be used to determine, based on a prediction result, how to perform an event, for example, recommend specific information to provide a specific business. Solutions for performing information or business recommendation based on a user behavior are understood, and details are not described in the present specification.

According to the event performance method based on user behavior prediction shown in FIG. 1, multimodal user data including at least behavior data is obtained, data of each modality is tokenized by using a sub-encoder of each modality branch in a prediction model to obtain a sub-feature of each modality through encoding, each sub-feature is further encoded to obtain a comprehensive feature, then a prediction advantage of a large language model is used to obtain a prediction result of a user behavior by using the comprehensive feature as an input, and finally an event policy of a target event is determined and performed based on the prediction result and the target event. The obtained multimodal user data is not limited to a certain event, a user behavior can be more accurately predicted by integrating behavior data with data of another modality, and an underlying cause can be better analyzed by using a reasoning capability of the large language model, making a prediction result more logical.

In addition, in one or more implementations of the present specification, before inputting the user data into each sub-encoder, for each modality, the server can further standardize the user data of the modality based on a predetermined data style of the modality to obtain standardized user data of the modality, and then input the standardized user data into the sub-encoder.

For example, a user behavior is: on Jan. 1, 2025, the user clicked on a “My Wallet” page to claim a red envelope at 12:31, and then purchased a 1 L carton of milk at a FamilyMart convenience store and paid 20.8 yuan at 15:31.

After standardization, behavior data is: <timestamp: 20250101-12: 31, action: <mywallet, Clip>, item: coupon>, <timestamp: 20250101-15: 31, action: <FamilyMart, Pay>, item: <milk, 20.8, 1 L>>.

Text data is: <appname: XXX, ZZZ, YY application market >, and the like.

In addition, in one or more implementations of the present specification, for a sub-encoder of a user behavior modality, the server can determining positional encoding of each piece of token (token) data in multiple manners.

For example, for the sub-encoder of the behavior data, the server can input the behavior data into the sub-encoder of the behavior data, and tokenize the behavior data. Each piece of token data corresponds to one user behavior.

In addition, the server can further determine, based on a sequence of user behaviors in the behavior data, positional encoding corresponding to each piece of token data obtained through tokenization. For example, if a user behavior sequence is user behaviors 1 to 8, it is determined that positional encoding is: token1 is [0], token2 is [1], and token3 is [2]. By analogy, token8 is [7].

In the behavior data, the user can perform only one operation at a same moment. Therefore, operations of the user are sequential. In this way, a behavior sequence of the user in different event scenarios in a time axis can be obtained.

However, this may lead to excessive user behavior positional encoding. For example, if there are 100 user operations, positional encoding needs to indicate a numerical range of 1 to 100. Therefore, positional encoding can be further compressed. For example, in one or more implementations of the present specification, determining positional encoding by the server is determining, based on an event performance procedure corresponding to the behavior data, positional encoding corresponding to each piece of token data obtained through tokenization. In other words, if multiple operations are in a same step of the event performance procedure, it indicates that a sequence of the multiple operations is less important or there is no sequence, and therefore same positional encoding can be set. For example, if the user behaviors 1 to 3 correspond to the first step of the event procedure, the user behavior 4 corresponds to the second step of the event procedure, and the user behaviors 5 to 8 correspond to the third step of the event procedure, positional encoding is: token1 to token3 all are [0], token4 is [1], and token5 to token8 all are [2].

Further, in one or more implementations of the present specification, the server can determine a user behavior of each event based on different historical events performed by the user, and then determine positional encoding on the event.

For example, the server determines, based on the behavior data, different events that the behavior data is used to perform.

Then, for each different event, token data obtained by tokenizing user behaviors corresponding to the event is determined.

Then, a sequence of the user behaviors corresponding to the event is determined based on an event performance procedure of the event.

Finally, positional encoding of each piece of token data of the event is determined based on the sequence.

In other words, positional encoding of different tokens is determined in a same event based on encoding ranges of different events. Because there is generally no sequence relationship between different events, positional encoding can also be determined by using this method.

Further, in the above implementation, positional encoding is for different events, but a general representation for the user needs to be obtained subsequently: a comprehensive feature. Therefore, when a sub-feature of a user behavior modality is determined, positional encoding of different events needs to be combined.

For example, for behavior data, the server performs unified encoding on obtained token data and positional encoding of different events by using a sub-encoder of a corresponding modality, to obtain a set of token data. When performing unified encoding, the server can first determine a causal relationship between different events. If there is no causal relationship, the server uses the events as parallel events and performs positional encoding alignment. If there is a causal relationship, the server sequentially performs different events based on the causal relationship, and sequentially moves positional encoding of two events. For example, if there is no causal relationship between two events, A and B, positional encoding is [0][1][2][3][4][5]. . . If there is a causal relationship between two events A and C, and A is a result of C, positional encoding [0][1][2][3][4][5] of tokens of the event A and positional encoding [0][1][2][3][4] of tokens of the event C are sequentially moved. The positional encoding of the tokens of the event A is unchanged, and the positional encoding of the tokens of the event C is changed to [6][7][8][9][10].

Then, the set of obtained token data is input into a self-attention weighting network of the sub-encoder of the modality for weighting, and then a weighting result is input into a feed-forward neural network of the sub-encoder of the modality to obtain a sub-feature of the modality.

In one or more implementations of the present specification, the encoder and the large language prediction layer of the prediction model can be separately trained. The encoder is trained in a self-supervised learning manner, to reduce training sample annotation requirements, and quickly and cost-effectively construct a training sample.

For example, behavior data of several users are obtained.

For behavior data of a same user, the behavior data is split into multiple segments.

Multiple pieces of multimodal user data of the user are constructed based on each segment of behavior data and data of another modality of the user as multiple training samples.

For each training sample of each user, the training sample is input into the encoder of the prediction model to obtain, by using a sub-encoder of each modality in the encoder and the overall encoder, a comprehensive feature corresponding to the training sample.

A function value of a loss function is determined based on the comprehensive feature of each training sample, and a model parameter of the encoder is adjusted based on the function value.

If a training sample is constructed by using user data of a same user for training, the function value of the loss function is determined based on a first difference of comprehensive features of training samples of a same user, where the first difference is negatively correlated with the function value.

If a training sample is constructed by using user data of different users, the function value of the loss function is determined based on a second difference of comprehensive features of training samples of different users, where the second difference is positively correlated with the function value.

Certainly, the server can also use the above two training samples at the same time for training to determine the function value of the loss function. The model parameter of the encoder is adjusted with the goal of minimizing the function value of the loss function.

In addition, for the large language model, an existing general LLM model can be used as a basis, with a comprehensive feature obtained from a trained encoder as an input and a user's actual behavior as annotation, to fine-tune the LLM model. The finely tuned LLM model is used as a large language prediction layer of the prediction model.

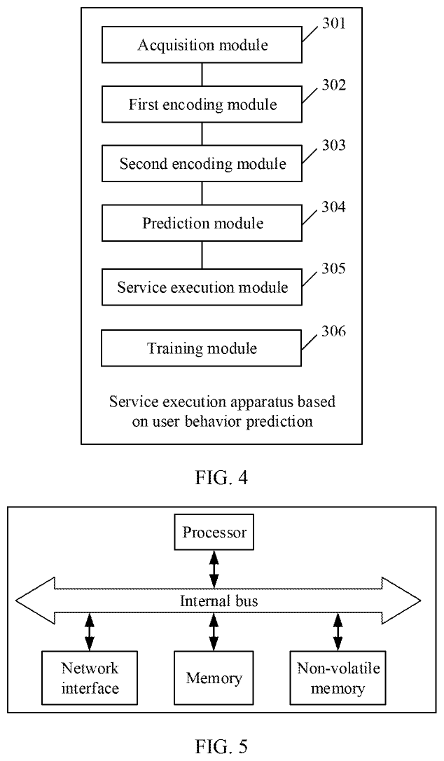

FIG. 4 is a schematic structural diagram illustrating an event performance apparatus based on user behavior prediction according to an implementation of the present specification. As shown in FIG. 4, the event performance apparatus based on user behavior prediction can be implemented as all or a part of an electronic device by using software, hardware, or a combination thereof. According to some implementations, the event performance apparatus based on user behavior prediction includes an acquisition module 301, a first encoding module 302, a second encoding module 303, a prediction module 304, and an event performance module 305. Details are as follows:

The acquisition module 301 is configured to obtain multimodal user data including at least behavior data of a user.

The first encoding module 302 is configured to: for user data of each modality, tokenize and encode the user data of the modality by using a sub-encoder corresponding to the modality in a trained prediction model to obtain a sub-feature of the modality.

The second encoding module 303 is configured to input the sub-feature of each modality into an overall encoder of the prediction model to obtain a comprehensive feature.

The prediction module 304 is configured to input the comprehensive feature into a large language prediction layer of the prediction model as descriptive information of a historical user behavior to obtain a prediction result of a user behavior output by the prediction model.

The event performance module 305 is configured to determine an event policy based on the prediction result and a target event to perform the event for the user based on the event policy.

In some implementations, the acquisition module 301 is configured to: obtain, based on predetermined duration, operation data of the user in different event scenarios in the duration as behavior data of the user, and obtain data of another modality of the user; and determine user data based on the behavior data and the data of the another modality, where the data of the another modality includes at least one of static data, text data, or graph data.

In some implementations, the acquisition module 301 is configured to obtain basic data of the user as static data of the user.

In some implementations, the acquisition module 301 is configured to obtain, based on a historical event performed by the user, text information in the historical event as text data of the user.

In some implementations, the acquisition module 301 is configured to: determine a relationship between the user and another object based on event information, where the another object includes at least one of another user, a device, or an environment; and construct graph data of the user based on the relationship.

In some implementations, the first encoding module 302 is configured to standardize the user data of the modality based on a predetermined data style of the modality to obtain standardized user data of the modality.

In some implementations, the first encoding module 302 is configured to: input the user data of the modality into the sub-encoder corresponding to the modality in the prediction model, and tokenize the user data of the modality to obtain each piece of token data of the modality; and continue to perform self-attention weighting on each piece of token data of the modality by using the sub-encoder of the modality, and then output the sub-feature of the modality through a feed-forward neural network of the sub-encoder of the modality.

In some implementations, dimensions of the sub-features output by the sub-encoders of the modalities are consistent.

In some implementations, the first encoding module 302 is configured to: for a sub-encoder of behavior data, input the behavior data into the sub-encoder of the behavior data, tokenize the behavior data, and determine, based on a sequence of user behaviors in the behavior data, positional encoding corresponding to each piece of token data obtained through tokenization, where each piece of token data corresponds to one user behavior.

In some implementations, the first encoding module 302 is configured to: for a sub-encoder of behavior data, input the behavior data into the sub-encoder of the behavior data, tokenize the behavior data, and determine, based on an event performance procedure corresponding to the behavior data, positional encoding corresponding to each piece of token data obtained through tokenization, where each piece of token data corresponds to one user behavior.

In some implementations, the first encoding module 302 is configured to: determine, based on the behavior data, different events that the behavior data is used to perform; determine, for each different event, token data obtained by tokenizing user behaviors corresponding to the event; determine, based on an event performance procedure of the event, a sequence of the user behaviors corresponding to the event; and determine positional encoding of each piece of token data of the event based on the sequence.

In some implementations, the first encoding module 302 is configured to: for behavior data, perform unified encoding on obtained token data and positional encoding of different events by using a sub-encoder of a corresponding modality, to obtain a set of token data; and input the set of token data into a self-attention weighting network of the sub-encoder of the modality for weighting, and then input a weighting result into a feed-forward neural network of the sub-encoder of the modality to obtain a sub-feature of the modality.

In some implementations, the prediction module 304 is configured to: obtain a prompt text of a predetermined large language model; use the comprehensive feature as the descriptive information of the historical user behavior; combine the prompt text and the descriptive information to obtain an input text; and input the input text into the large language prediction layer of the prediction model to obtain, as a prediction result, a user behavior sequence predicted by the prediction model.

In some implementations, the event performance module 305 is configured to: in response to the target event being a risk control event, match the behavior data with the prediction result based on an event requirement of the risk control event; and in response to determining that the behavior data does not match the prediction result, perform risk control for the user; or in response to determining that the behavior data matches the prediction result, skip performing risk control.

In some implementations, the event performance module 305 is configured to: in response to the target event being a recommendation event, match the prediction result with a recommendation range of the recommendation event based on the recommendation range; and send matched content in the recommendation range to the user.

In some implementations, the apparatus further includes a training module 306, configured to: obtain behavior data of several users; for behavior data of a same user, split the behavior data into multiple segments; construct multiple pieces of multimodal user data of the user based on each segment of behavior data and data of another modality of the user as multiple training samples; for each training sample of each user, input the training sample into the encoder of the prediction model to obtain, by using a sub-encoder of each modality in the encoder and the overall encoder, a comprehensive feature corresponding to the training sample; and determine a function value of a loss function based on the comprehensive feature of each training sample, and adjust a model parameter of the encoder based on the function value.

In some implementations, the training module 306 is configured to: determine the function value of the loss function based on a first difference of comprehensive features of training samples of a same user, where the first difference is negatively correlated with the function value; and/or determine the function value of the loss function based on a second difference of comprehensive features of training samples of different users, where the second difference is positively correlated with the function value.

The above apparatus implementation corresponds to the method implementation. For specific descriptions, references can be made to some of the descriptions of the method implementations. Details are omitted herein for simplicity. The apparatus implementation is obtained based on the corresponding method implementations, and has the same technical effects as the corresponding method implementations. For specific descriptions, references can be made to the corresponding method implementations.

An implementation of the present specification further provides a computer storage medium. The computer storage medium can store a plurality of instructions, and the instructions are adapted to be loaded by a processor and to perform the method in the implementation shown in FIG. 1. For a specific performance process, references can be made to the detailed descriptions in the implementation shown in FIG. 1. Details are omitted herein for simplicity.

The present specification further provides a computer program product. The computer program product stores at least one instruction. The at least one instruction is loaded by a processor to perform the method in the implementation shown in FIG. 1. For a specific performance process, references can be made to specific descriptions of the implementation shown in FIG. 1. Details are omitted herein for simplicity.

An implementation of the present specification further provides a schematic structural diagram of an electronic device shown in FIG. 5. As shown in FIG. 5, at a hardware level, the electronic device includes a processor, an internal bus, a network interface, a memory, and a non-volatile memory, and certainly may further include hardware required by other events. The processor reads a corresponding computer program from the non-volatile memory and runs the computer program in the memory, to implement the above event performance method based on user behavior prediction.

Certainly, in addition to a software implementation, the present specification does not exclude other implementations, such as a logic device or a combination of software and hardware. In other words, an performance entity of the following processing flow is not limited to each logic unit, but can also be hardware or logic devices.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be performed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively or additionally, the apparatus configured to implement various functions can even be considered as both a software module implementing the method and a structure in the hardware component.

Systems, apparatuses, modules, or units that are described in the above implementations can be for example implemented by using a computer chip or an entity, or by using a product with a certain function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, when the present specification is implemented, a function of each unit can be implemented in one or more pieces of software and/or hardware.

A person skilled in the art should understand that the implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the methods, the devices (systems), and the computer program products based on the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions performed by the computer or the processor of the another programmable data processing device generate an apparatus for implementing a specific function in one or more processes in the flowcharts and/or in one or more blocks in the block diagrams.

Alternatively or additionally, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively or additionally, these computer program instructions can be loaded onto a computer or another programmable data processing device, so that a series of operations and steps are performed on the computer or the another programmable device, to generate computer-implemented processing. Therefore, the instructions performed on the computer or the another programmable device provide steps for implementing a specific function in one or more procedures in the flowcharts and/or in one or more blocks in the block diagrams.

In a typical configuration, the computer includes one or more processors (CPUs), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that the implementations of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions performed by a computer, for example, a program module. Generally, the program module includes a routine, a program, an object, a component, a data structure, etc. executing a specific task or implementing a specific abstract data type. The present specification can alternatively or additionally be practiced in distributed computing environments in which tasks are performed by remote processing devices that are connected through a communication network. In the distributed computing environments, the program module can be located in local and remote computer storage media including storage devices.

The implementations in the present specification are described in a progressive manner. For same or similar parts in the implementations, references can be made to each other. Each implementation focuses on a difference from other implementations. Particularly, the system implementations are basically similar to the method implementations, and therefore are described briefly. For related parts, references can be made to some descriptions of the method implementations.

The above-mentioned descriptions are merely some implementations of the present specification, and are not intended to limit the present specification. A person skilled in the art can make various variations and changes to the present specification. Any modification, equivalent replacement, and improvement made in the spirit and principle of the present specification shall fall within the scope of the claims in the present specification.

The various embodiments described above can be combined to provide further embodiments. All of the U.S. patents, U.S. patent application publications, U.S. patent applications, foreign patents, foreign patent applications listed in the Application Data Sheet are incorporated herein by reference, in their entirety. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining multimodal user data of a plurality of modalities including at least a first modality of behavior data of a user;
for a modality of user data of the multimodal user data, tokenizing and encoding the user data of the modality by using a sub-encoder corresponding to the modality in a trained prediction model to obtain a sub-feature of the modality;
inputting a sub-feature of each modality of the multimodal user data into an encoder of the prediction model to obtain a comprehensive feature;
inputting the comprehensive feature into a large language prediction layer of the prediction model to obtain a prediction result of a user behavior; and
determining an event policy based on the prediction result and a target event to perform an event for the user based on the event policy.

2. The method according to claim 1, wherein the obtaining the multimodal user data including at least the first modality of the behavior data of the user includes:
obtaining operation data of the user in different event scenarios in a duration as the first modality of the behavior data of the user;
obtaining data of a second modality of the user; and
determining the multimodal user data based on the first modality of the behavior data and the data of the second modality,
wherein the data of the second modality includes at least one of static data, text data, or graph data.

3. The method according to claim 2, wherein the obtaining the data of the second modality of the user includes:
obtaining basic data of the user as static data of the user.

4. The method according to claim 2, wherein the obtaining the data of the second modality of the user includes:
obtaining, based on a historical event performed by the user, text information in the historical event as text data of the user.

5. The method according to claim 2, wherein the obtaining the data of the second modality of the user includes:
determining a relationship between the user and another object based on event information, wherein the another object includes at least one of another user, a device, or an environment; and
constructing graph data of the user based on the relationship.

6. The method according to claim 1, further comprising:
before the tokenizing the user data of the modality,
standardizing the user data of the modality based on a data style of the modality to obtain standardized user data of the modality.

7. The method according to claim 1, wherein the tokenizing the user data of the modality includes:
tokenizing the user data of the modality to obtain a piece of token data of the modality;
performing self-attention weighting on the piece of token data of the modality; and
outputting the sub-feature of the modality through a feed-forward neural network of the sub-encoder.

8. The method according to claim 7, wherein dimensions of sub-features output by sub-encoders corresponding to the plurality of modalities are consistent.

9. The method according to claim 7, wherein the tokenizing the user data of the modality to obtain the piece of token data of the modality includes:
inputting the behavior data into a sub-encoder corresponding to the first modality,
tokenizing the behavior data, and
determining, based on a sequence of user behaviors in the behavior data, positional encoding corresponding to each piece of token data obtained through tokenization,
wherein each piece of token data corresponds to one user behavior.

10. The method according to claim 7, wherein the tokenizing the user data of the modality includes:
inputting the behavior data into a sub-encoder corresponding to the first modality,
tokenizing the behavior data, and
determining, based on an event performance procedure corresponding to the behavior data, positional encoding corresponding to each piece of token data obtained through tokenization,
wherein each piece of token data corresponds to one user behavior.

11. The method according to claim 10, wherein the determining, based on the event performance procedure corresponding to the behavior data, the positional encoding corresponding to each piece of token data obtained through tokenization includes:
determining different events included in the behavior data;
determining, for each different event, token data obtained by tokenizing user behavior corresponding to the event;
determining, based on an event performance procedure of the event, a sequence of user behaviors corresponding to the event; and
determining positional encoding of each piece of token data of the event based on the sequence.

12. The method according to claim 11, wherein the performing self-attention weighting on each piece of token data of the modality by using the sub-encoder includes:
performing unified encoding on obtained token data and positional encoding of different events to obtain a set of token data;
inputting the set of token data into a self-attention weighting network of the corresponding sub-encoder for weighting; and
inputting a weighting result into a feed-forward neural network of the corresponding sub-encoder to obtain a sub-feature.

13. The method according to claim 1, wherein the inputting the comprehensive feature into the large language prediction layer of the prediction model to obtain the prediction result of the user behavior includes:
obtaining a prompt text of a large language model;
using the comprehensive feature as the descriptive information of the historical user behavior;
combining the prompt text and the descriptive information to obtain an input text; and
inputting the input text into the large language prediction layer of the prediction model to obtain, as a prediction result, a user behavior sequence predicted by the prediction model.

14. The method according to claim 1, wherein the determining the event policy based on the prediction result and the target event to perform the event for the user based on the event policy includes:
in response to the target event being a risk control event, matching the behavior data with the prediction result based on an event requirement of the risk control event; and
in response to determining that the behavior data does not match the prediction result, performing risk control for the user.

15. The method according to claim 1, wherein the determining the event policy based on the prediction result and the target event to perform the event for the user based on the event policy includes:
in response to the target event being a recommendation event, matching the prediction result with a recommendation range of the recommendation event based on the recommendation range; and
sending matched content in the recommendation range to the user.

16. The method according to claim 1, comprising training an encoder of the prediction model, the training including:
obtaining behavior data of several users;
for behavior data of a same user, splitting the behavior data into multiple segments;
constructing multiple pieces of multimodal user data of the user based on each segment of behavior data and data of another modality of the user as multiple training samples;
for each training sample of each user, inputting the training sample into the encoder of the prediction model to obtain, by using a sub-encoder of each modality in the encoder and the overall encoder, a comprehensive feature corresponding to the training sample;
determining a function value of a loss function based on the comprehensive feature of each training sample; and
adjusting a model parameter of the encoder based on the function value.

17. The method according to claim 16, wherein the determining the function value of the loss function based on the comprehensive feature of each training sample includes one or more of:
determining the function value of the loss function based on a first difference of comprehensive features of training samples of a same user, wherein the first difference is negatively correlated with the function value; or
determining the function value of the loss function based on a second difference of comprehensive features of training samples of different users, wherein the second difference is positively correlated with the function value.

18. A storage medium having computer executable instructions stored thereon, the computer executable instructions, when executed by one or more processors, enabling the one or more processors to, individually or collectively, implement acts including:
obtaining multimodal user data of a plurality of modalities including at least a first modality of behavior data of a user;
for a modality of user data of the multimodal user data, tokenizing and encoding the user data of the modality by using a sub-encoder corresponding to the modality in a trained prediction model to obtain a sub-feature of the modality;
inputting a sub-feature of each modality of the multimodal user data into an encoder of the prediction model to obtain a comprehensive feature;
inputting the comprehensive feature into a large language prediction layer of the prediction model to obtain a prediction result of a user behavior; and
determining an event policy based on the prediction result and a target event to perform an event for the user based on the event policy.

19. An electronic device comprising one or more processors and one or more memory devices, the one or more memory devices, individually or collectively, having computer executable instructions stored thereon, the computer executable instructions, when executed by the one or more processors, enabling the one or more processors to, individually or collectively, implement acts including:
obtaining multimodal user data of a plurality of modalities including at least a first modality of behavior data of a user;
for a modality of user data of the multimodal user data, tokenizing and encoding the user data of the modality by using a sub-encoder corresponding to the modality in a trained prediction model to obtain a sub-feature of the modality;
inputting a sub-feature of each modality of the multimodal user data into an encoder of the prediction model to obtain a comprehensive feature;
inputting the comprehensive feature into a large language prediction layer of the prediction model to obtain a prediction result of a user behavior; and
determining an event policy based on the prediction result and a target event to perform an event for the user based on the event policy.

20. The electronic device according to claim 19, wherein the obtaining the multimodal user data including at least the first modality of the behavior data of the user includes:
obtaining operation data of the user in different event scenarios in a duration as the first modality of the behavior data of the user;
obtaining data of a second modality of the user; and
determining the multimodal user data based on the first modality of the behavior data and the data of the second modality,
wherein the data of the second modality includes at least one of static data, text data, or graph data.
